(19) United States
(12) Patent Application Publication
(10) Pub. No.: US 2008/0137338 A1
(43) Pub. Date: Jun. 12, 2008

(54) ILLUMINATIVE JACK

(76) Inventor: Lai-Shun Lin, Tou-Chiao Industrial Zone (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/609,426

(22) Filed: Dec. 12, 2006

(51) Int. Cl. F21V 33/00; B66F 3/00

(52) U.S. Cl. 362/253; 254/124

(57) ABSTRACT

An illuminative jack comprises a lighting device disposed in a top plate and connected to a switch, thereby, when the user switches on the switch, the lighting device will be radiated by the power supplied by a power source, thus providing an illumination effect.

### BACKGROUND OF THE INVENTION

1. Field of the Invention

The present invention relates to an illuminative jack, wherein a lighting device is disposed in a top plate of the jack, and the lighting device is supplied by a power source and is controlled by a switch. By such arrangements, when the user switches on the switch, the lighting device will be radiated to illuminate a lifting object.

2. Description of the Prior Art

A jack is a device for lifting a heavy object and has the properties of easy moving and operation, so the jack is widely used in various industries, and vehicle maintenance in particular. Therefore, almost each vehicle is prepared for a jack.

Since the jack is provided for lifting the heavy object, in operation, the jack must be pushed to the bottom of the heavy object, such that the jack will be shaded by the shadow of the heavy object, and at night and the area of insufficient light in particular, and the user is unable to determine the position of a top plate of the jack. In order to solve this problem, the user has to push the jack to adjust the position of the jack by one hand, and to grip a lighting device by the other hand, so as to illuminate the position between the jack and the bottom of the heavy object, which is inconvenient to the user. Moreover, the user may have no lighting device to use, so the conventional jack cannot meet the users' requirement.

The present invention has arisen to mitigate and/or obviate the afore-described disadvantages.

### SUMMARY OF THE INVENTION

The primary objective of the present invention is to provide an illuminative jack comprises a lighting device disposed in a top plate and connected to a switch, thereby, when the user switches on the switch, the lighting device will be radiated by the power supplied by a power source.

Since the lighting device is disposed in the top plate of the jack, in operation, the lighting device will be radiated by switching on the switch. Thereby, when the user pushes the jack to the bottom of a heavy object, the bottom of the heavy object can be illuminated adequately. Thereby, the user can see the position of the jack opposite to the bottom of the heavy object clearly, so as to determine the distance and the position between the top plate and the lifted heavy object (since the top plate is in contact with the object directly, the lighting device disposed in the top plate has better illumination effect), and to prevent the jack from being influenced by insufficient light (a dark area in particular). Moreover, the lighting device is disposed in the top plate, so the function of the top plate will not be hindered, and the present jack is easy to operate and is practical.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a partially exploded view of an illuminative jack in accordance with the present invention;

FIG. 2 is a perspective view of the illuminative jack in accordance with the present invention;

FIG. 3 is an illustrative plan view of the illuminative jack in accordance with the present invention;

FIG. 4 is a cross sectional view of a top plate of the illuminative jack in accordance with the present invention; and

FIG. 5 is a perspective view of a pad of the illuminative jack in accordance with the present invention.

### DETAILED DESCRIPTION OF THE PREFERRED EMBODIMENTS

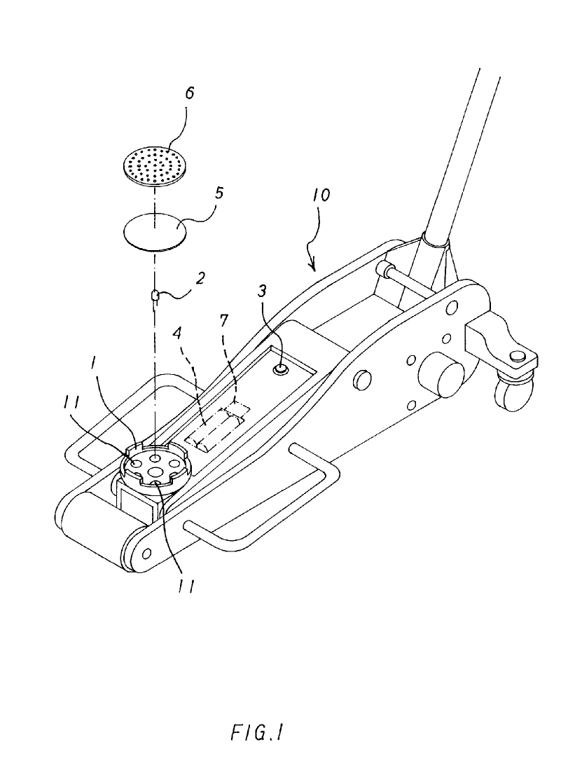

Referring to FIG. 1, an illuminative jack 10 in accordance with the present invention comprises a lighting device 2 disposed in a top plate 1 of the jack 10, and the lighting device 2 is controlled by a switch 3 and is connected to a power source 4 (as shown in FIG. 1, the lighting device can be a bulb, LED or other luminaries). Thereby, when the user switches on the switch 3, the lighting device 2 will be radiated by the power supplied by the power source 4, thus providing an illumination effect.

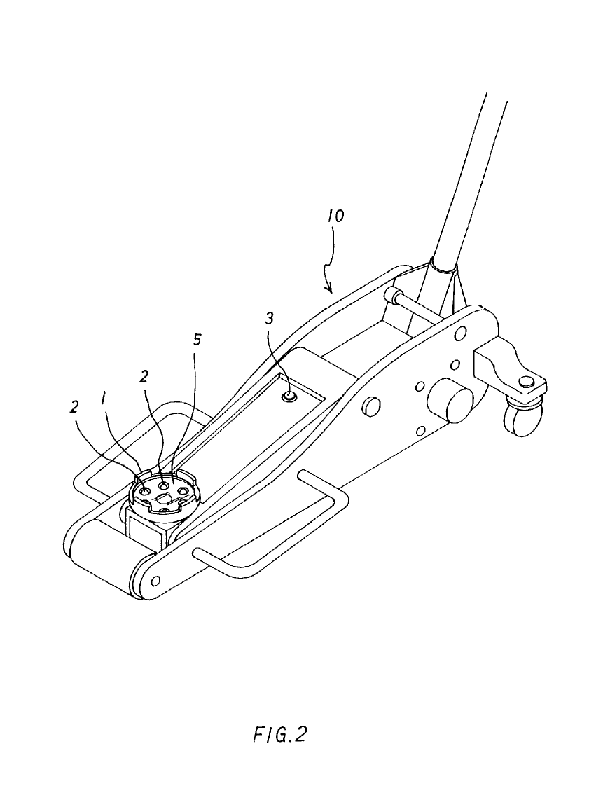

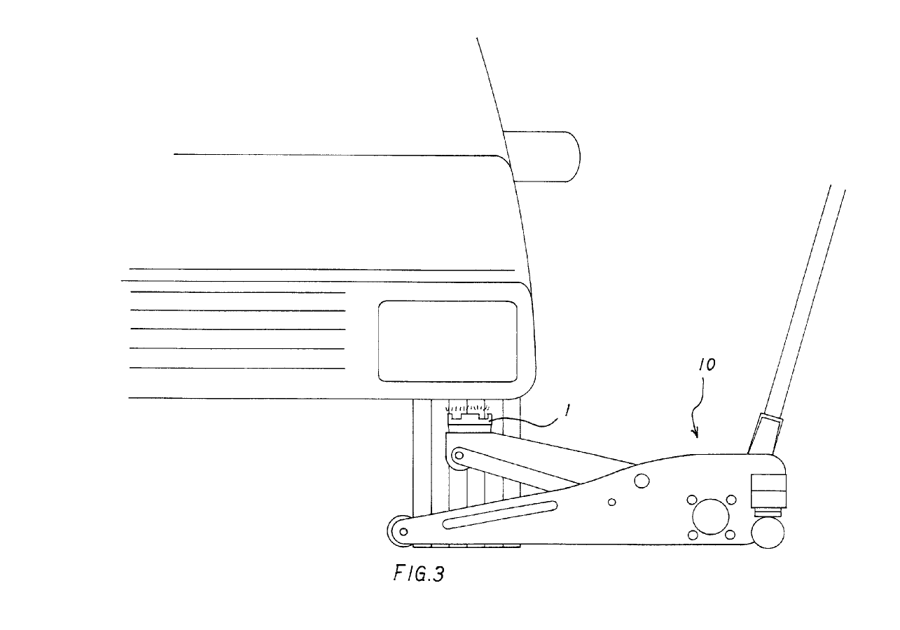

When the jack 10 of the present invention has an illumination effect (as shown in FIG. 2), the user can switch on the lighting device 2 via the switch 3 under a dark area according to the actual requirements (as shown in FIG. 3), so as to illuminate the bottom of a heavy object to be lifted directly, thus solving the problem of insufficient light. Thereby, the user needn't to grip the lighting device by the other hand, and the heavy object can be illuminated by adjusting the position of the jack 10 directly, so the present invention is easy to operate.

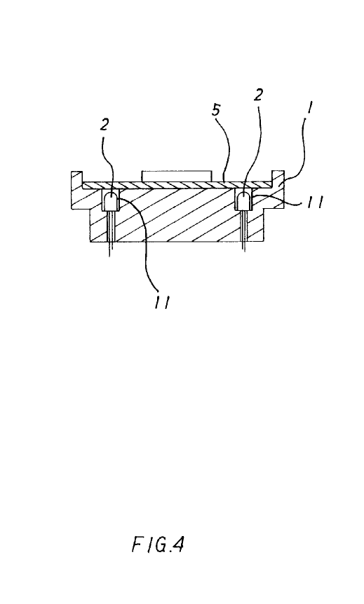

In addition, the top plate 1 of the jack 10 is defined with a plurality of receiving grooves 11 (as shown in FIG. 4) for receiving the lighting device 2, and a transparent cover 5 is provided for protecting the lighting device 2.

Further, a pad 6 is covered on an upper portion of the transparent cover 5, so as to prevent the transparent cover 5 from being abraded when the lighting device 2 is not in use.

The switch 3 of the present invention can be connected to a timer 7 in such a manner that when the user switches on the switch 3, the output power of the power source 4 can be cut off automatically after a scheduled time (such as three minutes), thus preventing the waste of the power when the user forgets to switch off the switch 3.

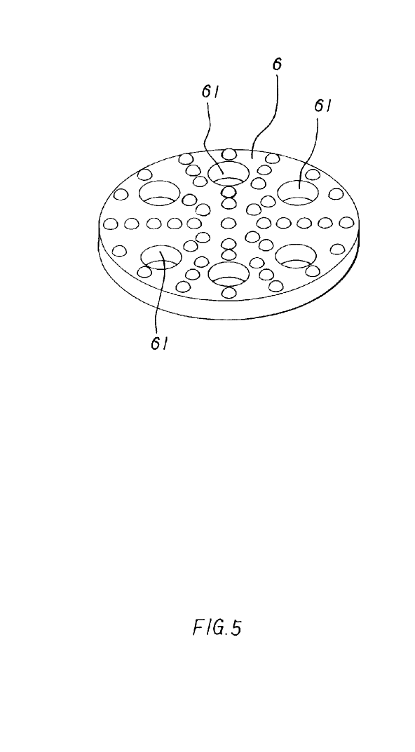

The pad 6 can be defined with a plurality of through holes 61 located correspondingly to the lighting device 2 of the top plate 1 (as shown in FIG. 5), so as to illuminate the lifting object directly.

While we have shown and described various embodiments in accordance with the present invention, it should be clear to those skilled in the art that further embodiments may be made without departing from the scope of the present invention.

What is claimed is:

1. An illuminative jack comprises a lighting device disposed in a top plate of the jack, the lighting device being controlled by a switch and being connected to a power source, thereby, when the user switches on the switch, the lighting device being radiated by the power supplied by the power source, thus providing an illumination effect.

2. The illuminative jack as claimed in claim 1, wherein the top plate is defined with a plurality of receiving grooves for receiving the lighting device, and a transparent cover is provided for protecting the lighting device.

3. The illuminative jack as claimed in claim 1 or 2, wherein the switch is connected to a timer in such a manner that when the user switches on the switch, the output power of the power source is cut off automatically after a scheduled time.

4. The illuminative jack as claimed in claim 2, wherein a pad is covered on an upper portion of the transparent cover, so as to prevent the transparent cover from being abraded when the lighting device is not in use.

5. The illuminative jack as claimed in claim 2, wherein the pad covered on the upper portion of the transparent cover has a plurality of through holes located correspondingly to the lighting device.
